(19) United States
(12) Patent Application Publication
(10) Pub. No.: US 2021/0070032 A1
(43) Pub. Date: Mar. 11, 2021

(54) ENGRAVED ROLLER FOR FLEXOGRAPHIC AND GRAVURE PRINTING

(71) Applicant: Harper Corporation of America, Charlotte, NC (US)

(72) Inventors: Ronald Lee Harper, Iron Station, NC (US); Anthony Gene Donato, Charlotte, NC (US); Sean Franklin Teufler, Charlotte, NC (US)

(21) Appl. No.: 17/011,104

(22) Filed: Sep. 3, 2020

Related U.S. Application Data
(60) Provisional application No. 62/896,264, filed on Sep. 5, 2019.

(51) Int. Cl. B41C 1/05; B41N 7/06; B41F 5/24

(52) U.S. Cl. CPC B41C 1/05; B41F 5/24; B41N 7/06

(57) ABSTRACT

A roller for use with a printing apparatus to transfer a liquid to a plate or substrate is provided. The roller, also referred to as a cylinder, has an engraved surface with a linear cell-contained channel engraving pattern. The linear cell-contained channel engraving pattern has a linear channel at a channel engraved angle and a plurality of cells with pockets at a cell pocket positioned angle located within the linear channel. An engraving pattern and method of using the pattern to reduce spitting in printing processes are provided.

### CROSS-REFERENCE TO RELATED APPLICATION

This application claims priority from U.S. Provisional Patent Application No. 62/896,264, filed on Sep. 5, 2019, in the United States Patent and Trademark Office. The disclosure of which is incorporated herein by reference in its entirety.

### FIELD OF THE INVENTION

The present invention relates to a roller having an engraved pattern for flexographic and gravure printing.

### BACKGROUND OF THE INVENTION

In the flexographic industry, there are many open cell engravings, but none providing a combination of “full carry” of inks, moiré resistance and UV spitting resistance. Moiré is an interference pattern due to conflict of an imaged plate screen and an engraved screen on an Anilox (liquid transfer) roller. “Full carry” is the ability of a cell to completely fill without efficiency loss in the transfer. UV spitting is from the buildup of heavier solids that collect and cause an issue from the blade/Anilox contact area. Other channel engravings are able to meet one or two of the above criteria, but none provide a remedy for all three.

UV spitting is a particularly troublesome aspect of flexographic and gravure printing. The process of inking an anilox roll, shearing off excess ink via use of a doctor blade and transferring a consistent ink film is the basis of flexographic printing. However, a recurring challenge for flexographic printers is UV ink spitting. Spitting can be commonly described as the escape of the ink from the confines of the blade/anilox contact point. Once past the blade, the ink builds up on the opposite side of the blade. Accumulation of ink releases and creates print flaws, typically in the form of randomly-placed teardrop shapes on the printed image.

Thus, there is a need for a roller with an engraved surface that overcomes the aforementioned disadvantages and problems.

### SUMMARY OF THE INVENTION

The present invention relates to a laser engraved roller to be used in flexographic and gravure printing, a linear cell-contained channel engraving pattern and a method of using the same to reduce spits in printing.

In an embodiment of the invention, a roller with an engraved surface for use with an apparatus to transfer a liquid to a plate or substrate is provided. The roller comprises a cylinder having an engraved surface with a linear cell-contained channel engraving pattern, wherein the linear cell-contained channel engraving pattern has a linear channel at a channel engraved angle and a plurality of cells with pockets at a cell pocket positioned angle located within the linear channel.

In an embodiment of the invention, an engraved pattern on the surface of a roller for use with an apparatus to transfer a liquid to a plate or substrate having a linear cell-contained channel engraving pattern is provided. The linear cell-contained channel engraving pattern has a linear channel at a channel engraved angle and a plurality of cells with pockets at a cell pocket positioned angle.

In an embodiment of the invention, a method of using a roller to reduce spitting in printing is provided. The method comprises providing a printing apparatus having a roller, which is also referred to as a cylinder with an engraved surface, wherein the engraved surface has a linear cell-contained channel engraving pattern having a linear channel at a channel engraved angle and a plurality of cells with pockets at a cell pocket positioned angle, and transferring a liquid from the engraved surface of the roller to a plate or substrate.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1A illustrates a roller for use in flexographic and gravure printing applications in accordance with the present invention.

FIG. 1B illustrates another view of the roller of FIG. 1A.

FIG. 2 illustrates another type of roller referred to as a sleeve for use in flexographic and gravure printing applications in accordance with the present invention.

FIG. 3 illustrates a cell having cell walls and a cell wall depth.

FIG. 4 illustrates an image of geometric angles for an engraving in accordance with the present invention having a 120-degree channel engraved angle and a 60-degree cell pocket positioned angle.

FIG. 5A is an image of a cross channel slice of a 60° channel drawn through a white light picture.

FIG. 5B is a histogram showing the relationship between the total channel depth to the cross-channel cell (pocket) wall depth from the channel bottom of the channel of FIG. 5A.

FIG. 6A is an image of a slice line down the middle of a channel in a white light picture and a histogram showing the cell (pocket) wall depth to the total channel depth and the number of cells in a linear inch.

FIG. 6B is a histogram showing the cell (pocket) wall depth to the total channel depth and the number of cells in a linear inch of the channel of FIG. 6A.

FIG. 7A is a 3D image with histogram created from data obtained measuring the volume and geometric features of a ceramic engraved anilox roller.

FIG. 7B is a histogram of FIG. 7A.

FIG. 8A is the 3D image of FIG. 7A with the image flipped to see the cells from looking up from the bottom.

FIG. 8B is a histogram of FIG. 8A.

FIG. 9 is another view of the 3D image of FIG. 7A.

FIG. 10 is a white light picture having a 60 degree channel.

FIG. 11A is a white light picture.

FIG. 11B is a histogram of FIG. 11A.

FIG. 12A is an image with the line drawn in a white light picture over fewer cells to provide a close-up.

FIG. 12B is a histogram of FIG. 12A.

FIG. 13A is an image with the line drawn in the channel itself in a white light picture.

FIG. 13B is a histogram of FIG. 13A.

FIG. 14A is an image of a 3 cell line in 120 degree channel in a white light picture.

FIG. 14B is a histogram of FIG. 14A.

FIG. 15A is an image of a second position for a line drawn across the channels in a white light picture.

FIG. 15B is a histogram of FIG. 15A.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention, but does not limit the scope or substance of the invention.

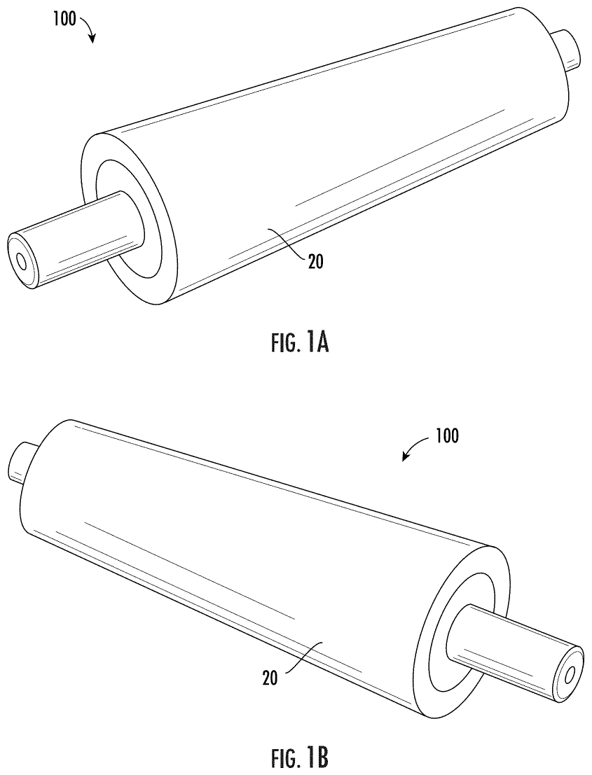

Referring to the figures, FIG. 1A illustrates an engraved roller 100 for use in flexographic and gravure printing applications in accordance with the present invention. FIG. 1B illustrates another view of the engraved roller of FIG. 1A. Engraved roller 100 is used with a printing apparatus to transfer a liquid to a plate or substrate. Preferably, the roller is an anilox roller as used in flexography. The roller may have one or more bands of different engravings.

FIG. 2 illustrates another type of engraved roller 200 referred to as a sleeve for use in flexographic and gravure printing applications in accordance with the present invention. Engraved roller 100 and engraved roller 200 each have an engraved surface 20. However, engraved roller 100 and engraved roller 200 are mounted differently in a printing apparatus. Engraved roller 100 has journals whereas engraved roller 200 has a hollow inside with has multiple designs that allow the hollow roller to be mounted in a self-centering method. Both types of rollers can be used in flexographic and gravure printing applications in accordance with the present invention.

Engraved rollers 100 and 200 are each coated by a ceramic or other coating or material. The engraved surface is preferably laser engraved. Coating materials include, but are not limited to, ceramics, metals, and any other laser engravable materials.

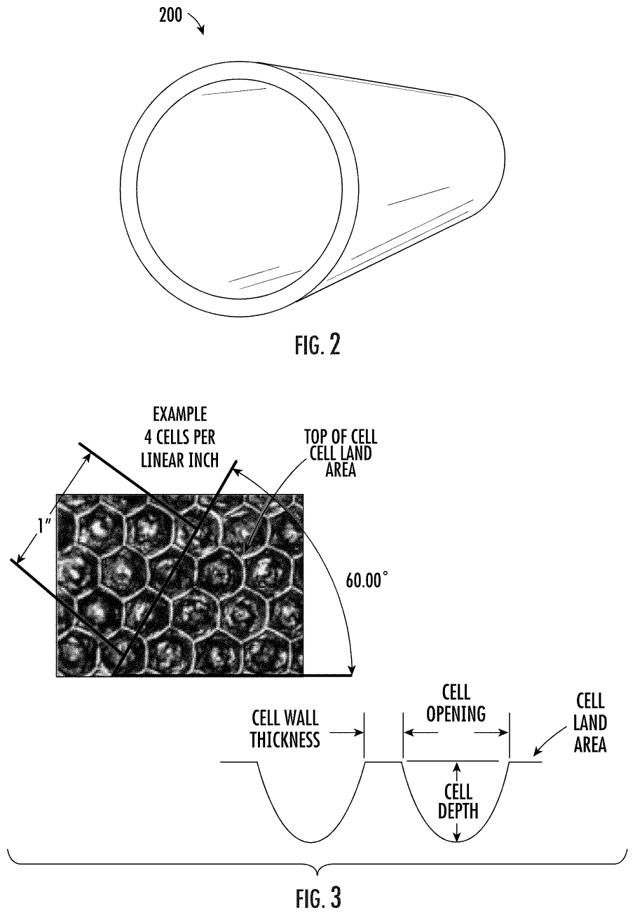

Engraved surface 20 has a plurality of linear channels and a plurality of cells within each of the linear channels. The engraved surface slows down liquid flow. The liquid is any material having a viscosity that allows for flow through the linear channels. Examples of liquids include, but are not limited to, inks, adhesives, varnishes including special effect varnishes, and primers. The cells are preferably equally spaced in a given linear channel. As shown in FIG. 3, a cell has a cell pocket that serves as a liquid holding well. The number of equally spaced cells may vary by application and can be in a range of 10 to 5000 cells (pockets) per linear inch. Each cell is defined by two cross-channel walls that are lower than the channel walls and perpendicular to the channel walls. The linear cell-contained channel structure can be configured and engraved as a pattern in a range of 30° to 150° (degrees) in relation to an axial direction of the coated cylinder. The linear cell-contained channel structure also can be configured and engraved as a pattern in a range of 30° to 89° and/or 91° to 150° (degrees) in relation to an axial direction of the coated cylinder. The linear channel in a fixed measured angle for a given roller, utilizes the base cell profile of a hex. A pocket in the cell bottom is created with cross-walls that are at a cell wall depth in a range of from 20% to 80% of a total channel depth, with approximately 40% to 60% of the total channel depth being preferred. The total channel depth is equal to the cell wall depth plus a free flow liquid channel depth. The free flow liquid channel refers to that portion of the channel above the cell walls but within the channel where the liquid freely flows. The free flow liquid channel depth and the total channel depth is illustrated in a histogram shown in the figures herein.

The achievable volume of liquid that can be available for transfer to a printing plate or substrate is measured in BCM (Billion Cubic Microns per Square Inch) and the amount of BCM is related to the engravable cells (pockets) per linear inch that can be formed in the engraved surface and still maintain the cell cross channel walls in the 20% to 80% range of the total channel depth.

In the present invention, there is a relationship between the channel engraved angle and the cell (pockets) positioned angle. The channel engraved angle can be in a range from 30° to 150° in conjunction with the cells having walls that travel across the channel to capture and hold liquid. Alternatively, the channel engraved angle can be in a range from 30° to 89° and/or 91° to 150° (degrees). The cell (pocket) positioned angle is essentially determined by the channel engraved angle (30° to 150°) or (30° to 89° and/or 91° to 150°) as the cell (pocket) positioned angle is in a range of 20% to 80%, preferably 40% to 60%, of the channel engraved angle.

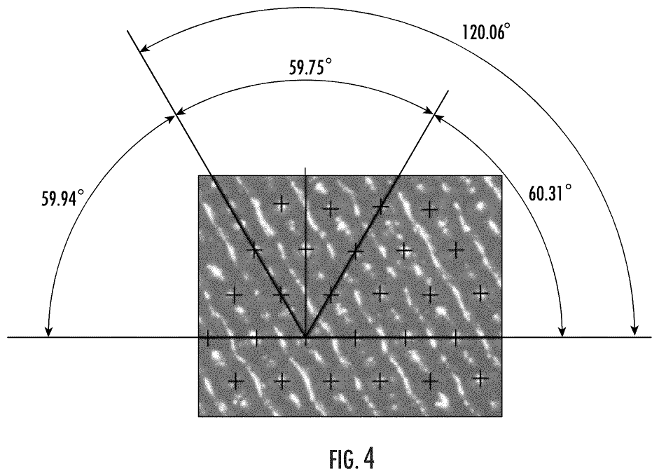

FIG. 4 illustrates geometric angles for an engraving having a 120 degree channel engraved angle and a 60 degree cell pocket positioned angle. In the example shown in FIG. 4, the angle of the channel is shown at 120° measured as the difference between the angle vector and the axis of the anilox. As shown in FIG. 4, cross points are positioned in the cell pockets (wells).

The pockets allow for control of the liquid flow that results in the filling of the cells. The linear cell-contained channel engraving pattern of the present invention provides hydraulic relief to a liquid by keeping the liquid flowing as the cells are filled and transferring the liquid to a printing plate or substrate. Without the pressure relief, the collected solids would otherwise cling to a doctor blade that is metering the liquid off the roller surface. When more liquid accumulates on the blade edge then its surface energy can hold, “spit” (a process of flicking ink from the blade/roller contact area) is arbitrarily released onto the plate or substrate surface causing print defects. Among the other advantages of the linear cell-contained channel engraving pattern of the present invention is that it provides a slim profile for moiré pattern creation (printed interference between the plate or a substrate and the roller cell angle).

Thus, the invention provides engraving such as by laser into ceramic or other engravable materials yet provides hydraulic pressure relief for UV inks and other liquids without sacrificing transfer properties or increased moiré potential. The functionality of the cell profile allows for increased run speeds without the concern for creating a greater likelihood of UV inks spitting. The linear cell-contained channel engraving pattern also provides foaming relief to adhesives and varnishes that are prone to microbubbles from agitation. Other print disciplines, like particle inks, can also benefit from the cell channel flow technology.

The engraved roller and engraving pattern of the present invention provides for consistent lower cross-channel wall height and consistent cell bottom profile while maintaining “carry” and volume targets (both properties of closed cell engravings) but without interfering with the liquid carrying plate or substrate image angles needed to print. Unlike present technology, the engraved roller of the present invention provides for linear channeling in the engraving angle that results in the consistent transfer of ink and other liquids to traditional angled imaged printing plates or substrates. Among the other advantages of the engraved roller and engraving pattern of the present invention are flexographic and gravure printing without pin holing and the increasing of opacity. Depending upon the plate or substrate and surface, the engraved roller and engraving pattern of the present invention may also assist with lay down of liquid.

In an embodiment of the present invention, a method of using a roller to reduce spitting in printing is provided. The method comprises providing a printing apparatus having a roller with a cylinder having an engraved surface, wherein the engraved surface has a linear cell-contained channel engraving pattern having a linear channel at a channel engraved angle and a plurality of cells with pockets at a cell pocket positioned angle, and transferring an ink or other liquid from the engraved surface of the roller to a plate or substrate.

### EXAMPLES

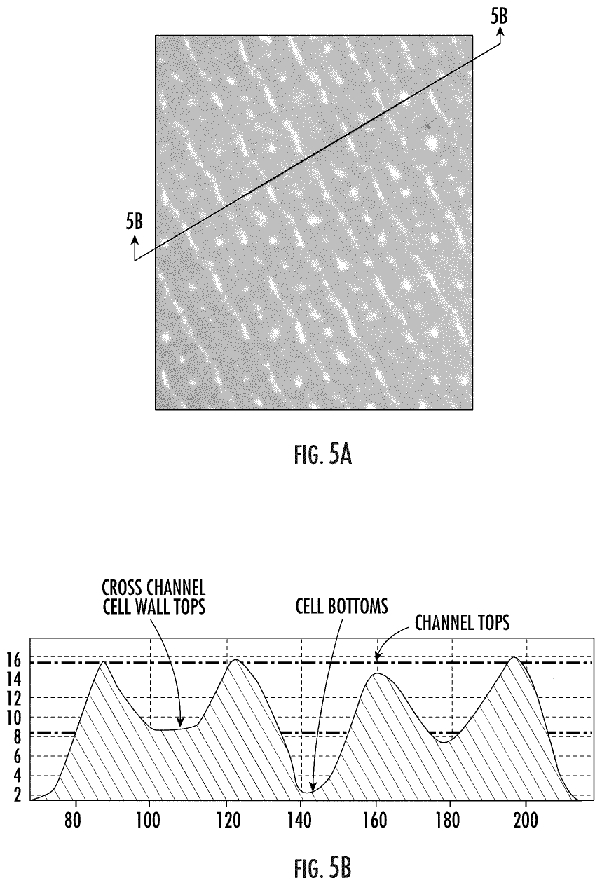

A 3DQC Microdynamics Interferometer measuring device was used to measure the volume and geometric features of a ceramic engraved anilox roller(s) in accordance with the present invention. Images and histograms prepared from the data and scans obtained are set forth in FIGS. 5A-15B.

FIG. 5A is an image of a cross channel slice of a 60° channel drawn through a white light picture. FIG. 5B is a histogram showing the relationship between the total channel depth to the cross-channel cell (pocket) wall depth from the channel bottom of the channel of FIG. 5A. In reference to FIGS. 5A and 5B, drawing a slice perpendicular to the channel going across the channels, the difference between the “Channel Tops” and the “Cross Channel Cell Wall Tops” is the free liquid flowing channels and the difference between the “Cross Channel Cell Wall Tops” and the “Cell (Pocket) Bottoms” is the flow interrupting pockets.

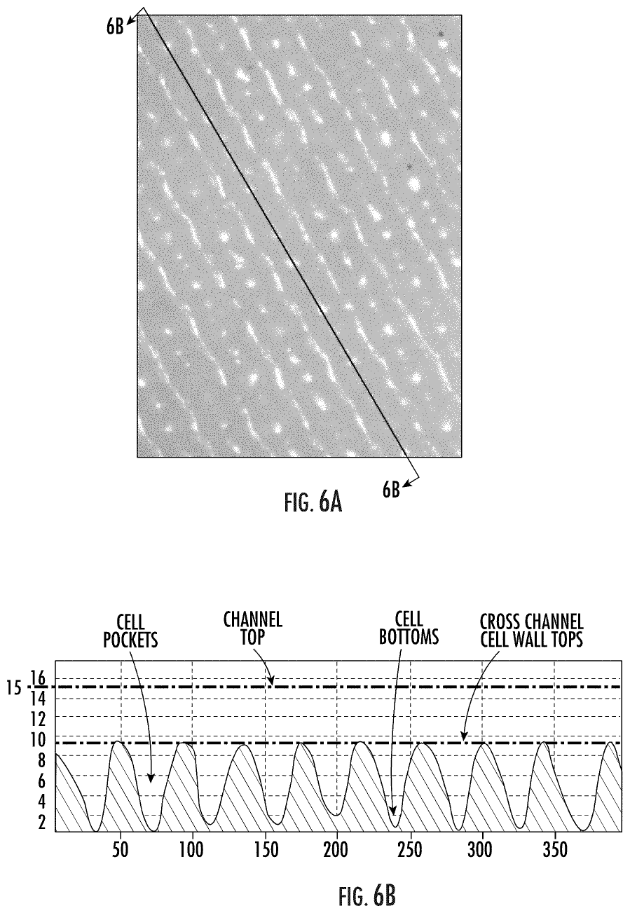

FIG. 6A is an image of a slice line down the middle of a channel in a white light picture and a histogram showing the cell (pocket) wall depth to the total channel depth and the number of cells in a linear inch. FIG. 6B is a histogram showing the cell (pocket) wall depth to the total channel depth and the number of cells in a linear inch of the channel of FIG. 6A. Referring to FIGS. 6A and 6B, drawing a slice parallel to the channel going in center of the channel direction shows the relationship between the liquid catching cell (pockets) and the channel tops where the doctor blade wipe. The cell pockets in the channel are unique.

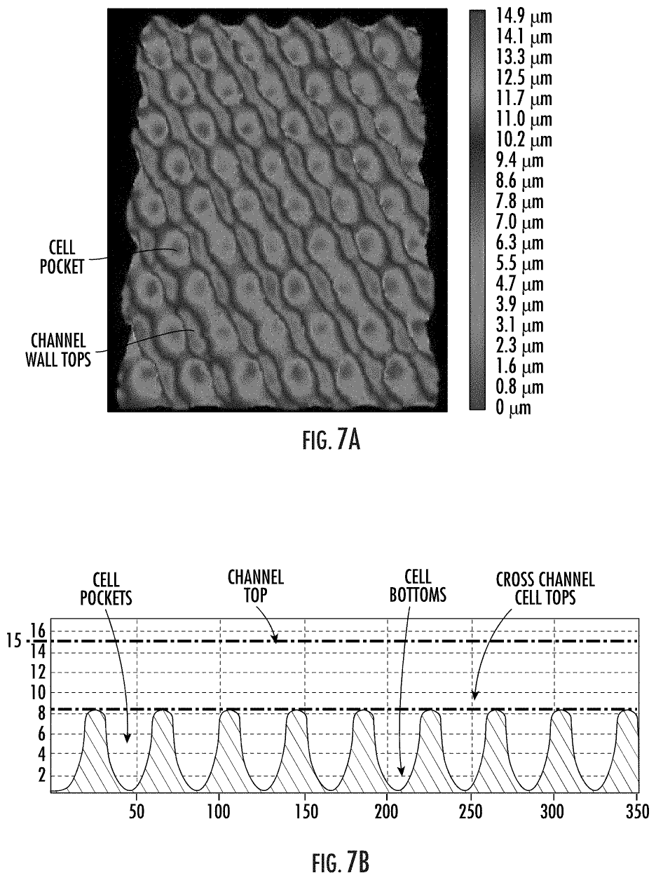

FIG. 7A is a 3D image with histogram created from data obtained measuring the volume and geometric features of a ceramic engraved anilox roller. FIG. 7B is a histogram of FIG. 7A. Referring to FIGS. 7A and 7B, drawing a slice in the axial direction, the 3DQC builds an approximate composite profile.

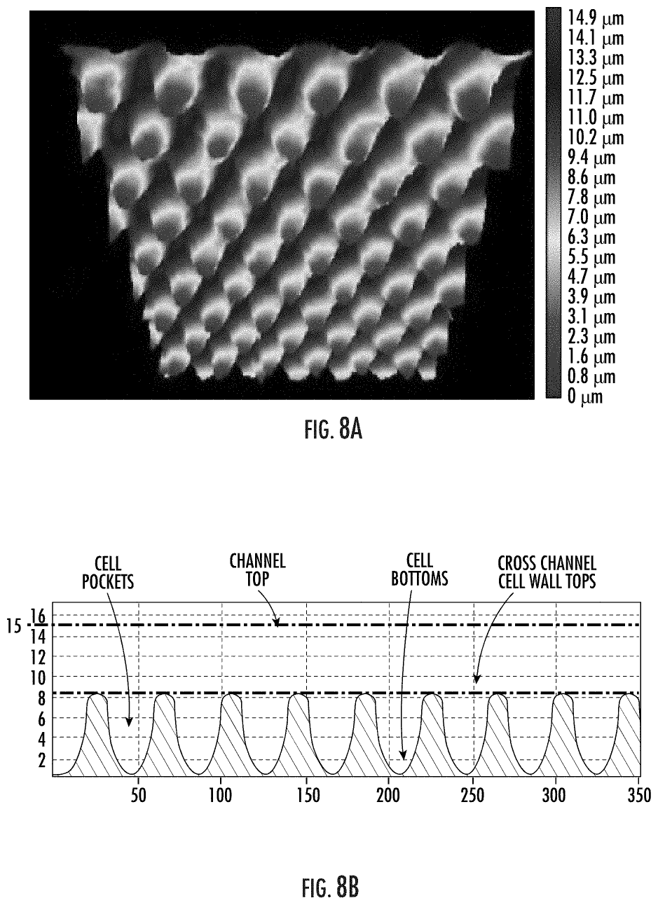

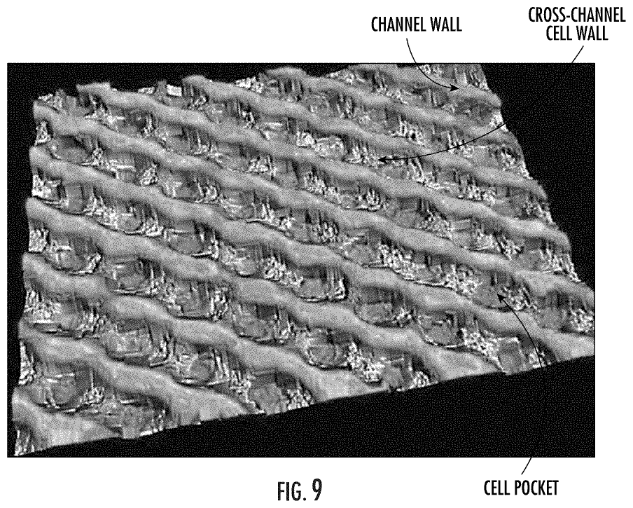

FIG. 8A is the 3D image of FIG. 7A with the image flipped to see the cells from looking up from the bottom. FIG. 8B is a histogram of FIG. 8A. Referring to FIGS. 8A and 8B, drawing a slice in the roller axial direction the 3DQC builds an approximate composite profile. In this view the composite is the same as the previous even though the view is looking from the bottom up.

FIG. 9 is another view of the 3D image of FIG. 7A. In this view, the channel wall, the cross-channel cell wall, and the cell pocket are shown.

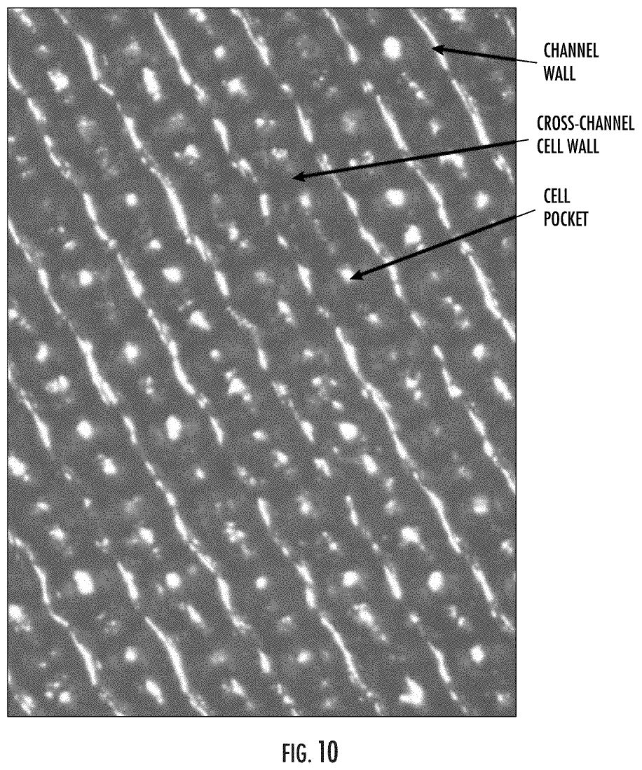

FIG. 10 is a white light picture having a 60 degree channel. In this view, the channel wall, the cross-channel cell wall, and the cell pocket are shown.

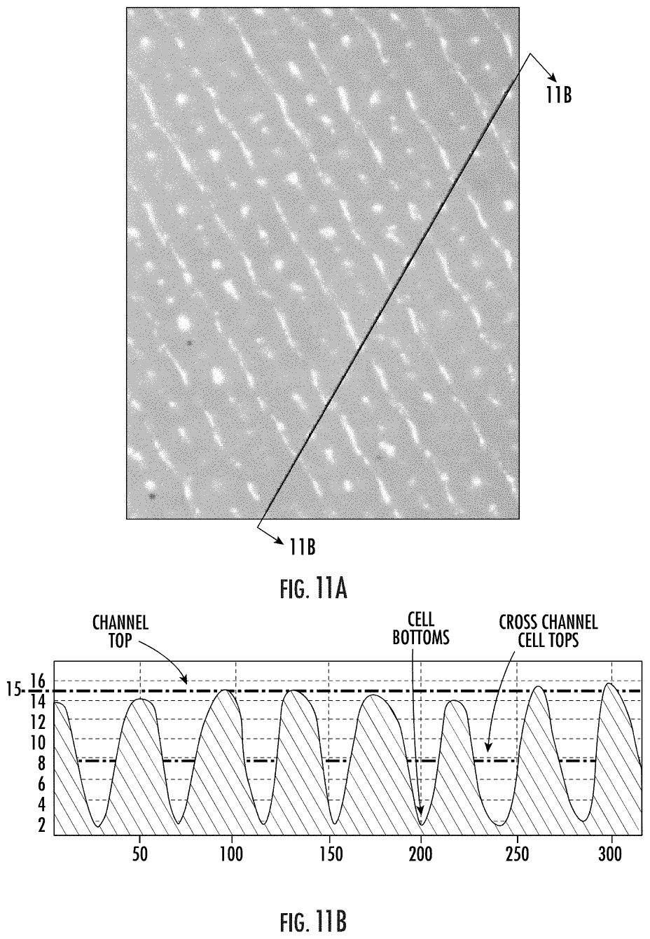

FIG. 11A is a white light picture. FIG. 11B is a histogram of FIG. 11A. Referring to FIGS. 11A and 11B, the slice line was drawn through the cell pocket to illustrate the full depth of the cells as compared to other cells in the channel as the channel threads itself across and around the roller.

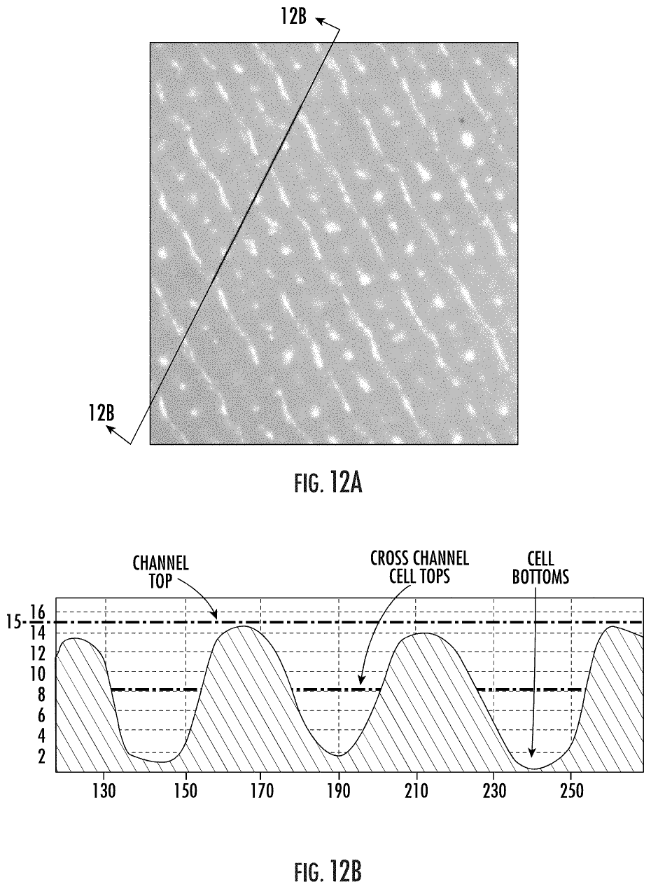

FIG. 12A is an image with the line drawn in a white light picture over fewer cells to provide a close-up. FIG. 12B is a histogram of FIG. 12A. Referring to FIGS. 12A and 12B, the slice line was drawn through only three cell pockets to illustrate the full depth of the cells and proportion to other cells in the channel as the channel itself threads across and around the roller.

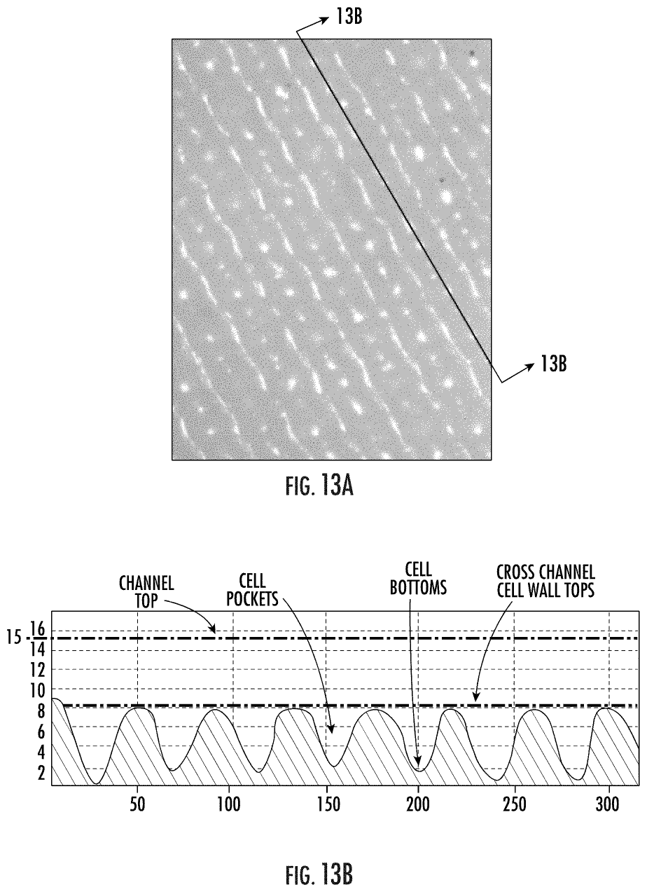

FIG. 13A is an image with the line drawn in the channel itself in a white light picture. FIG. 13B is a histogram of FIG. 13A. Referring to FIGS. 13A and 13B, FIG. 13 is similar to FIG. 6B where the slice was drawn parallel to the channel going in the center of the channel direction through seven cell pockets instead of nine in FIG. 6B to show the liquid catching cell (pockets) in a different proportion.

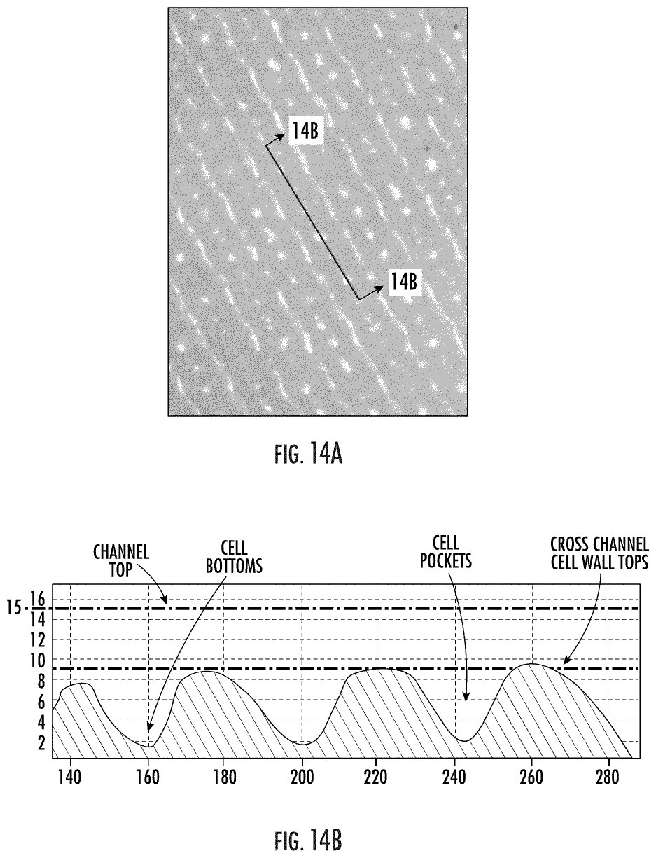

FIG. 14A is an image of a 3 cell line in 120 degree channel in a white light picture. FIG. 14B is a histogram of FIG. 14A. FIGS. 14A and 14B are illustrating the same view as FIG. 6B except only showing three cells so more detail can be profiled.

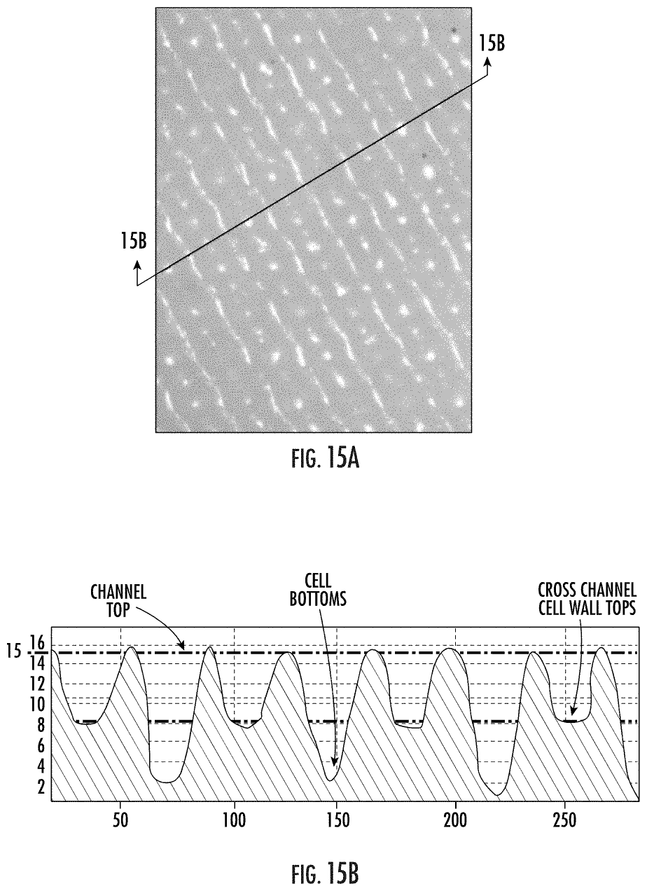

FIG. 15A is an image of a second position for a line drawn across the channels in a white light picture. FIG. 15B is a histogram of FIG. 15A. Referring to FIGS. 15A and 15B, FIG. 15B is similar to FIG. 5B where the slice was drawn perpendicular to the channel going through seven channels to illustrate the depth difference between the cross channel walls and the cell pockets.

Other experiments were conducted to determine laser engraving parameters for a consistent controlled linear engraving. Testing of actual printing using banded anilox rollers and single band anilox rollers was conducted and tested successfully in comparison to the standard 60 hex closed cells engraving. Printed product comparisons have been made to 30 degree and non-linear channeled engravings.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A roller for use with a printing apparatus to transfer a liquid to a plate or substrate, the roller comprising:
a cylinder having an engraved surface with a linear cell-contained channel engraving pattern,
wherein the linear cell-contained channel engraving pattern has a linear channel at a channel engraved angle and a plurality of cells with pockets at a cell pocket positioned angle located within the linear channel.

2. The roller according to claim 1, wherein the roller has an engraved surface.

3. The roller according to claim 1, wherein the engraved surface is laser engraved.

4. The roller according to claim 1, wherein the cylinder is coated by a ceramic or other engravable coating or material.

5. The roller according to claim 1, wherein the liquid is any material having a viscosity that allows for flow through a linear channel of the linear cell-contained channel engraving pattern.

6. The roller according to claim 5, wherein the liquid is selected from the group consisting of an ink, an adhesive, a varnish, and a combination thereof.

7. The roller according to claim 1, wherein the linear cell-contained channel engraving pattern is in a range of 30° to 150° (degrees) in relation to an axial direction of the coated cylinder.

8. The roller according to claim 1, wherein the linear cell-contained channel engraving pattern is in a range of 30° to 89° or 91° to 150° (degrees) in relation to an axial direction of the coated cylinder.

9. The roller according to claim 1, wherein the linear cell-contained channel engraving pattern has a base cell profile of a hex.

10. The roller according to claim 1, wherein a cell of the linear cell-contained channel engraving pattern has cross-walls and a pocket in a bottom of the cell having a cell wall depth in a range of from 20% to 80% of a total channel depth.

11. The roller according to claim 10, wherein the total channel depth is equal to the cell wall depth in addition to a free flow liquid channel depth.

12. The roller according to claim 9, wherein a cell of the linear cell-contained channel engraving pattern has cross-walls and a pocket in a bottom of the cell having a cell wall depth in a range of from 40% to 60% of a total channel depth.

13. The roller according to claim 1, wherein the channel engraved angle is in a range from 30° to 150°.

14. The roller according to claim 1, wherein the channel engraved angle is in a range from 30° to 89° or 91° to 150° (degrees).

15. The roller according to claim 1, wherein the cell pocket positioned angle is in a range of 20% to 80% of the channel engraved angle.

16. The roller according to claim 15, wherein the cell pocket positioned angle is in a range of 40% to 60% of the channel engraved angle.

17. An engraving pattern for a roller having a cylinder comprising:
a linear cell-contained channel engraving pattern having a linear channel at a channel engraved angle, and a plurality of cells with pockets at a cell pocket positioned angle.

18. The engraving pattern according to claim 17, wherein the linear cell-contained channel engraving pattern is in a range of 30° to 150° (degrees) in relation to an axial direction of the cylinder.

19. The engraving pattern according to claim 17, wherein the linear cell-contained channel engraving pattern is in a range of 30° to 89° or 91° to 150° (degrees) in relation to an axial direction of the cylinder.

20. The engraving pattern according to claim 17, wherein the linear cell-contained channel engraving pattern has a base cell profile of a hex.

21. The engraving pattern according to claim 17, wherein a cell of the linear cell-contained channel engraving pattern has cross-walls and a pocket in a bottom of the cell having a cell wall depth in a range of from 20% to 80% of a total channel depth.

22. The engraving pattern according to claim 21, wherein the total channel depth is equal to the cell wall depth in addition to a free flow liquid channel depth.

23. The engraving pattern according to claim 17, wherein a cell of the linear cell-contained channel engraving pattern has cross-walls and a pocket in a bottom of the cell having a cell wall depth in a range of from 40% to 60% of a total channel depth.

24. The engraving pattern according to claim 17, wherein the channel engraved angle is in a range from 30° to 150°.

25. The engraving pattern according to claim 17, wherein the channel engraved angle is in a range from 30° to 89° or 91° to 150° (degrees).

26. The engraving pattern according to claim 17, wherein the cell pocket positioned angle is in a range of 20% to 80% of the channel engraved angle.

27. The roller according to claim 26, wherein the cell pocket positioned angle is in a range of 40% to 60% of the channel engraved angle.

28. A method of using a roller to reduce spitting in printing, the method comprising:
providing a printing apparatus having a roller having an engraved surface, wherein the engraved surface has a linear cell-contained channel engraving pattern having a linear channel at a channel engraved angle and a plurality of cells with pockets at a cell pocket positioned angle; and
transferring a liquid from the engraved surface of the roller to a plate or substrate.
